(19) United States
(12) Patent Application Publication
(10) Pub. No.: US 2018/0031722 A1
(43) Pub. Date: Feb. 1, 2018

(54) SYSTEMS AND METHODS EMPLOYING A MENU-BASED GRAPHICAL USER INTERFACE (GUI) TO DERIVE A SHEAR SLOWNESS LOG

(71) Applicant: Halliburton Energy Services, Inc., Houston, TX (US)

(72) Inventors: Rong Shu, Sugar Land, TX (US); Arthur Cheng, Houston, TX (US); William Michael Langley, Houston, TX (US); Jian Liu, Beijing (CN)

(21) Appl. No.: 15/551,189

(22) PCT Filed: Mar. 17, 2015
(86) PCT No.: PCT/US2015/021106

§ 371 Date: Aug. 15, 2017

(51) Int. Cl. G01V 1/50

(52) U.S. Cl. CPC G01V 1/50; G01V 2210/74; G01V 2210/6222

(57) ABSTRACT

Methods and systems for acoustic data analysis are described. An example method includes obtaining digitized acoustic signals corresponding to acoustic signals collected by a logging tool deployed in a downhole environment. The method also includes providing a graphical user interface (GUI) that enables a user to view representations of the digitized acoustic signals and related coherence data. The method also includes receiving user-input regarding adjustment and inversion options for the digitized acoustic signals via a menu of the GUI. The method also includes deriving a shear slowness log for the downhole environment in accordance with the received user-input.

### BACKGROUND

In the quest for hydrocarbon reservoirs, companies employ many data-gathering techniques. The most detailed, albeit localized, data comes from well logging. During the well-drilling process, or shortly thereafter, logging instruments pass through the well bore to collect information about the surrounding formations. The information is traditionally collected in “log” form, i.e., a table, chart or graph of measured data values as a function of instrument position. The most sought-after information relates to the location and accessibility of hydrocarbon gases and fluids.

Resistivity, density, and porosity logs have proven to be particularly useful for determining the location of hydrocarbon gases and fluids. These logs are “open hole” logs, i.e., log measurements that are taken before the formation face is sealed with tubular steel casing. Meanwhile, acoustic logging tools provide measurements of acoustic wave propagation speeds through the formation. There are multiple wave propagation modes that can be measured, including compressional and flexural. Taken together, the propagation speeds of these various modes often indicate formation density and porosity.

Acoustic logging measurements are also valuable for determining the velocity structure of subsurface formations, which information is useful for migrating seismic survey data to obtain accurate images of the subsurface formation structure. Subsurface formations are often anisotropic, meaning that the acoustic waves propagation speed depends on the direction in which the wave propagates. Most often the formations, even when anisotropic, are relatively isotropic in the horizontal plane. This particular version of anisotropy is often called vertical transverse isotropy (VTI). Accurate imaging requires that such anisotropy be accounted for during the migration process. When sufficiently precise, such imaging enables reservoirs to be delineated from surrounding formations, and further indicates the presence of formation boundaries, laminations, and fractures, which information is desired by the reservoir engineers as they formulate a production strategy that maximizes the reservoir's economic value. Accurate or otherwise useful acoustic logging results are not automatic and are affected at least in part by decisions regarding how acoustic logging measurements are collected and how collected acoustic logging measurements are processed.

### BRIEF DESCRIPTION OF THE DRAWINGS

Accordingly, there are disclosed herein in the drawings and detailed description systems and methods employing a menu-based graphical user interface (GUI) to derive a shear slowness log. In the drawings:

FIG. 1 is a schematic diagram showing an illustrative logging-while-drilling (LWD) environment;

FIG. 2 is a schematic diagram showing an illustrative wireline logging environment;

FIG. 3A is a schematic diagram showing an illustrative acoustic logging tool;

FIG. 3B is a schematic diagram showing an illustrative receiver having azimuthal sensitivity;

FIG. 4 is a graph showing illustrative receive waveforms;

FIG. 5 is a block diagram showing illustrative tool electronics;

FIG. 6 is a block diagram showing an illustrative computer system;

FIG. 7 is a block diagram showing illustrative functions of a menu-based GUI;

FIGS. 8A-8E are images showing illustrative menu-based GUI screenshots;

FIG. 9 is a flowchart of an illustrative acoustic logging and data analysis method; and

FIG. 10 is a flowchart of another illustrative acoustic logging and data analysis method involving a menu-based GUI.

It should be understood, however, that the specific embodiments given in the drawings and detailed description do not limit the disclosure. On the contrary, they provide the foundation for one of ordinary skill to discern the alternative forms, equivalents, and modifications that are encompassed in the scope of the appended claims.

### DETAILED DESCRIPTION

Disclosed herein are systems and methods employing a menu-based graphical user interface (GUI) to derive a shear slowness log. The menu-based GUI facilitates obtaining an accurate or otherwise useful shear slowness log by enabling a user to visualize acoustic signals collected by a logging tool deployed in a downhole environment, to see the effect of selecting different filtering or masking options for acoustic signals, and/or to see the effect of selecting different inversion options on shear slowness log results. In at least some embodiments, the menu-based GUI enables a user to visualize time coherency and frequency coherency plots corresponding to received acoustic signals and to make decisions regarding filtering, masking, or inversion options in response to the time coherency and frequency coherency plots. Further, in at least some embodiments, the menu-based GUI enables a user to visualize a derived shear slowness log together with other logs and to adjust filtering, masking, or inversion options in response to the derived shear slowness log together with other logs (another shear slowness log is derived based on the adjustments). The filtering, masking, or inversion options related to the menu-based GUI may be selected for an initial version of digitized acoustic signals as well as for any subsequent or adjusted versions of digitized acoustic signals. Shear slowness logs obtained using the menu-based GUI can be applied to anisotropy analysis and visualization operations. Additionally or alternatively, shear slowness logs obtained using the menu-based GUI can be applied to seismic tie-in operations, mechanical properties analysis, and/or field planning.

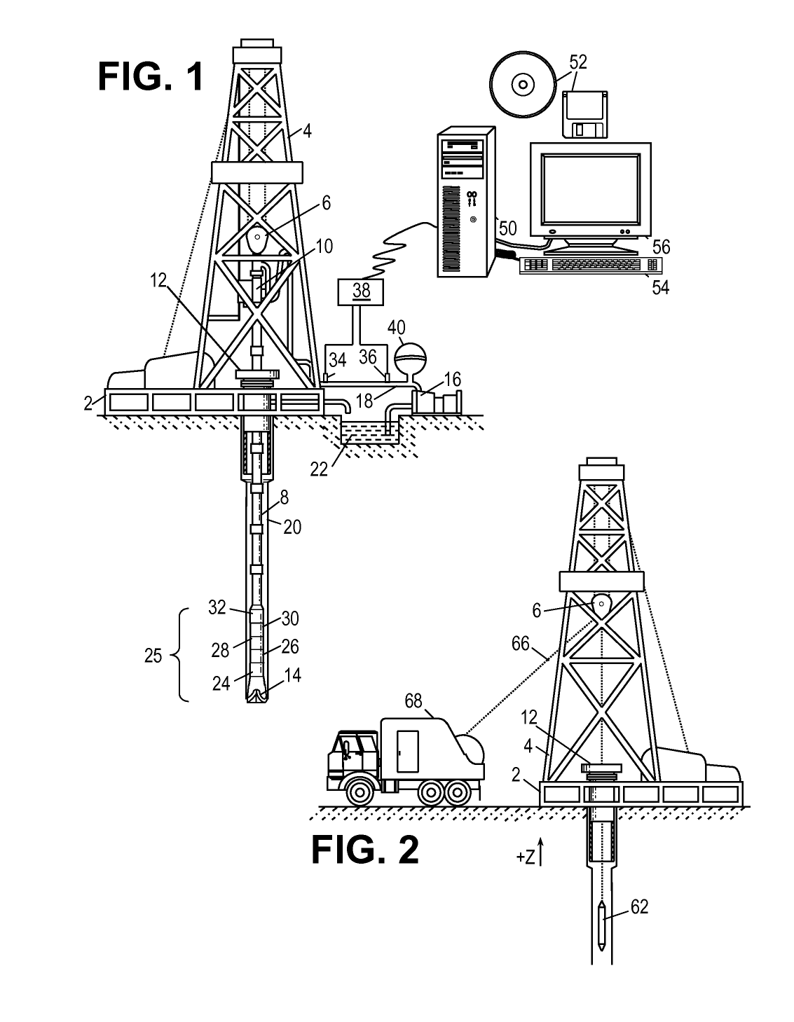

The disclosed systems and methods employing a menu-based GUI to derive a shear slowness log can be best understood in an application context. Accordingly, FIG. 1 shows an illustrative logging while drilling (LWD) environment. A drilling platform 2 is equipped with a derrick 4 that supports a hoist 6. The rig operator drills an oil or gas well using a string of drill pipes 8. The hoist 6 suspends a top drive 10 that rotates the drill string 8 as it lowers the drill string through the wellhead 12. Connected to the lower end of the drill string 8 is a drill bit 14. The bit 14 is rotated and drilling accomplished by rotating the drill string 8, by use of a downhole motor near the drill bit, or by both methods. Recirculation equipment 16 pumps drilling fluid through supply pipe 18, through top drive 10, and down through the drill string 8 at high pressures and volumes to emerge through nozzles or jets in the drill bit 14. The drilling fluid then travels back up the hole via the annulus formed between the exterior of the drill string 8 and the borehole wall 20, through a blowout preventer, and into a retention pit 24 on the surface. On the surface, the drilling fluid is cleaned and then recirculated by recirculation equipment 16. The drilling fluid carries cuttings from the base of the bore to the surface and balances the hydrostatic pressure in the rock formations.

At the lowermost part of drill string 8, a bottomhole assembly (BHA) 25 includes thick-walled tubulars called drill collars, which add weight and rigidity to aid the drilling process. The thick walls of these drill collars make them useful for housing instrumentation and LWD sensors. Thus, for example, the BHA 25 may include a natural gamma ray detector 24, a resistivity tool 26, an acoustic logging tool 28, a neutron porosity tool 30, and a control/telemetry module 32. Other tools and sensors can also be included in the BHA 25, including position sensors, orientation sensors, pressure sensors, temperature sensors, vibration sensors, etc. From the various BHA sensors, the control/telemetry module 32 collects data regarding the formation properties and/or various drilling parameters, and stores the data in internal memory. In addition, some or all of the data is transmitted to the surface by, e.g., mud pulse telemetry, acoustic telemetry, electromagnetic telemetry, etc.

In a mud pulse telemetry example, telemetry module 32 modulates a resistance to drilling fluid flow to generate pressure pulses that propagate to the surface. One or more pressure transducers 34, 36 (isolated from the noise of the mud pump 16 by a desurger 40) convert the pressure signal into electrical signal(s) for a signal digitizer 38. The digitizer 38 supplies a digital form of the pressure signals to a computer 50 or some other form of a data processing device. Computer 50 operates in accordance with software (which may be stored on information storage media 52) and user input received via an input device 54 to process and decode the received signals. The resulting telemetry data may be further analyzed and processed by computer 50 to generate a display of useful information on a computer monitor 56 or some other form of a display device. For example, a driller could employ this system to derive a shear slowness log and/or perform other operations using a menu-based GUI as described herein.

At various times during the drilling process, the drill string 8 may be removed from the borehole as shown in FIG. 2. Once the drill string has been removed, logging operations can be conducted using a wireline logging tool string 62, i.e., a sensing instrument sonde suspended by a cable 66 having conductors for transporting power to the tool and telemetry from the tool to the surface. The wireline logging tool string 62 can include an acoustic density logging tool similar to the LWD embodiment described hereinbelow. Other formation property sensors can additionally or alternatively be included to measure formation properties as the wireline logging tool string 62 is pulled uphole. A logging facility 68 collects measurements from the wireline logging tool string 62, and includes computing facilities for processing and storing the measurements gathered by the logging tool. In at least some embodiments, logging facility 68 employs a menu-based GUI to derive a shear slowness log and/or to perform other operations as described herein.

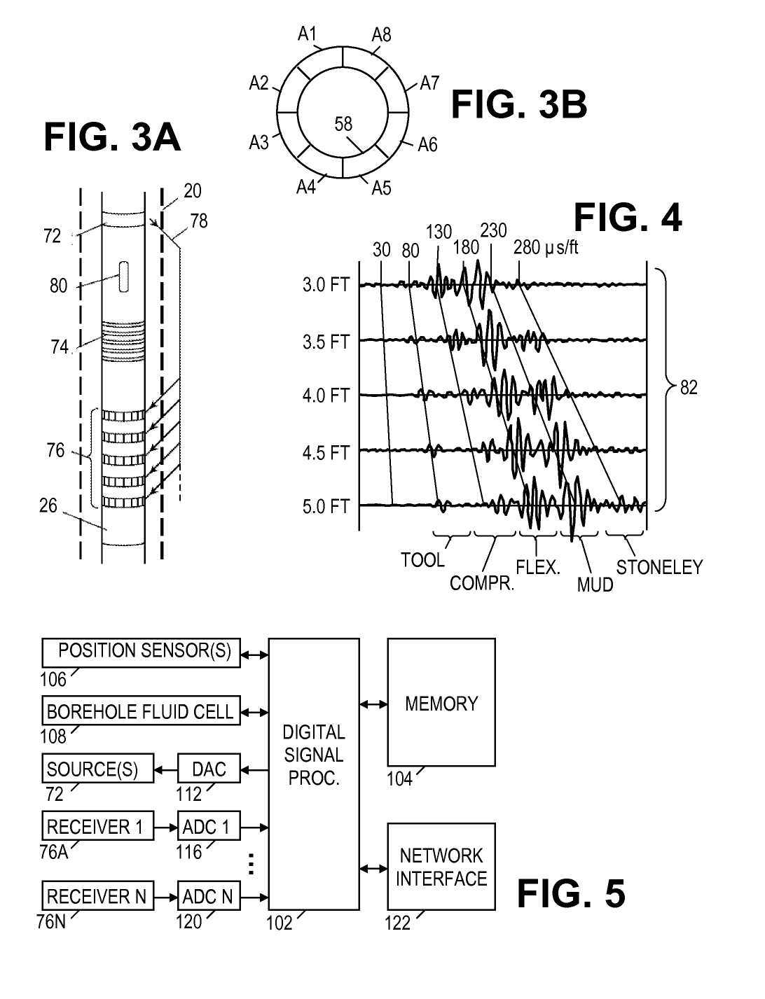

FIG. 3A shows an illustrative LWD embodiment of acoustic logging tool 26 in a borehole 20. The logging tool 26 includes a monopole acoustic source 72, an acoustic isolator 74, an array of acoustic receivers 76, and a multi-pole source 80. The multi-pole source may be a dipole, crossed-dipole, quadrupole, hexapole, or higher-order multi-pole transmitter. Some tool embodiments may include one acoustic source that is configurable to generate different wave modes rather than having separate transmitter sources, but in each case the source(s) are designed to generate acoustic waves 78 that propagate through the formation and are detected by the receiver array 76. The acoustic source may be made up of piezoelectric elements, bender bars, or other transducers suitable for generating acoustic waves in downhole conditions. The contemplated operating frequencies for the acoustic logging tool are in the range between 0.5 kHz and 30 kHz, inclusive. The operating frequency may be selected on the basis of a tradeoff between attenuation and wavelength in which the wavelength is minimized subject to requirements for limited attenuation. Subject to the attenuation limits on performance, smaller wavelengths may offer improved spatial resolution of the tool.

The acoustic isolator 74 serves to attenuate and delay acoustic waves that propagate through the body of the tool from the source 72 to the receiver array 76. Any standard acoustic isolator may be used. Receiver array 76 can include multiple sectorized receivers spaced apart along the axis of the tool. (One such sectorized receiver 58 is illustrated in cross-section in FIG. 3B). Although five receivers are shown in FIG. 3A, the number can vary from one to sixteen or more.

Each sectorized receiver 58 includes a number of azimuthally spaced sectors. Referring momentarily to FIG. 3B, a receiver 58 having eight sectors A1-A8 is shown. However, the number of sectors can vary and is preferably (but not necessarily) in the range between 4 and 16, inclusive. Each sector may include a piezoelectric element that converts acoustic waves into an electrical signal that is amplified and converted to a digital signal. The digital signal from each sector is individually measured by an internal controller for processing, storage, and/or transmission to an uphole computing facility. Though the individual sectors can be calibrated to match their responses, such calibrations may vary differently for each sector as a function of temperature, pressure, and other environmental factors. Accordingly, in at least some embodiments, the individual sectors are machined from a cylindrical (or conical) transducer. In this fashion, it can be ensured that each of the receiver sectors will have matching characteristics.

When the acoustic logging tool is enabled, the internal controller controls the triggering and timing of the acoustic source 72, and records and processes the signals from the receiver array 76. The internal controller fires the acoustic source 72 periodically, producing acoustic pressure waves that propagate through the fluid in borehole 20 and into the surrounding formation. As these pressure waves propagate past the receiver array 76, they cause pressure variations that can be detected by the receiver array elements.

The receiver array signals may be processed by the internal controller to determine the true formation anisotropy and shear velocity, or the signals may be communicated to the uphole computer system for processing. The measurements are associated with borehole position (and possibly tool orientation) to generate a log or image of the acoustical properties of the borehole. The log or image is stored and ultimately displayed for viewing by a user. In at least some embodiments, acoustic signals collected by an acoustic logging tool such as logging tool 26 are analyzed, visualized, filtered, masked, and adjusted using options provided by a menu-based GUI to derive a shear slowness log and/or to perform other operations as described herein.

FIG. 4 shows a set of illustrative amplitude versus time waveforms 82 detected by the receiver array 76 in response to one triggering of the source 72. The receivers are located at 3, 3.5, 4, 4.5, and 5 ft from the acoustic source, and various slowness value slopes are shown to aid interpretation. The time scale is from about 80 to 1500 μs. Each of the waveforms is shown for a corresponding receiver as a function of time since the transmitter firing. (Note the increased time delay before the acoustic waves reach the increasingly distant receivers.) After recording the waveforms, the internal controller typically normalizes the waveforms so that they have the same signal energy.

The detected waveforms represent multiple waves, including waves propagating through the body of the tool (“tool waves”), compression waves from the formation, shear waves from the formation, waves propagating through the borehole fluid (“mud waves”), and Stoneley waves propagating along the borehole wall. Each wave type has a different propagation velocity which separates them from each other and enables their velocities to be independently measured using, e.g., the semblance processing techniques disclosed by B. Mandal, U.S. Pat. No. 7,099,810 “Acoustic logging tool having a quadrupole source”.

The receiver array signals may be processed by a downhole controller to determine parameters such as V_{S} (the formation shear wave velocity) and V_{C} (the formation compression wave velocity), or the signals may be communicated to an uphole computer system for processing. (Though the term “velocity” is commonly used, the measured value is normally a scalar value, i.e., the speed. The speed (velocity) can also be equivalently expressed in terms of slowness, which is the reciprocal of speed.) When the velocity is determined as a function of frequency, the velocity may be termed a “dispersion curve”, as the variation of velocity with frequency causes the wave energy to spread out as it propagates.

The acoustic velocity measurements are associated with borehole position (and possibly tool orientation) to generate a log or image of the acoustical properties of the borehole. The log or image is stored and ultimately displayed for viewing by a user. In at least some embodiments, deriving such acoustic velocity measurement logs involves visualization, filtering, masking, and inversion options provided by a menu-based GUI to derive a shear slowness log and/or to perform other operations as described herein.

The illustrative acoustic logging tool 26 may further include a fluid cell to measure acoustic properties of the borehole fluid. Specifically, the fluid cell measures V_{M}, the velocity of compression waves in the borehole fluid and ρ_{M}, the density of the borehole fluid. (Alternatively, the acoustic impedance Z_{M}=ρ_{M}V_{M} can be measured.) Various suitable fluid cells exist in the art, such as e.g., the fluid cell employed by the Halliburton CAST-V™ wireline tool, or that disclosed by B. Mandal, U.S. Pat. No. 6,957,700 “Self-calibrated ultrasonic method of in-situ measurement of borehole fluid acoustic properties”. The fluid cell can be operated in a manner that avoids interference from firings of the source 72, e.g., the borehole fluid property measurements can be made while the source 72 is quiet, and the formation wave velocity measurements can be made while the fluid cell is quiet. Alternatively, the acoustic properties of the borehole fluid can be measured at the surface and subjected to corrections for compensate for temperature and pressure variation.

FIG. 5 is a functional block diagram of the illustrative acoustic logging tool 26. A digital signal processor 102 operates as an internal controller for tool 26 by executing software stored in memory 104. The software configures the processor 102 to collect measurements from various measurement modules such as position sensor 106 and fluid cell 108. (Note that these modules can alternatively be implemented as separate tools in a wireline sonde or bottomhole assembly, in which case such measurements would be gathered by a control/telemetry module.)

The software further configures the processor 102 to fire the source(s) 72 via a digital to analog converter 112, and further configures the processor 102 to obtain receive waveforms from receiver array 76 via analog to digital converters 116-120. The digitized waveforms can be stored in memory 104 and/or processed to determine compression and shear wave velocities. As explained further below, the processor can process the dispersion curve measurements to derive at least formation shear velocity and acoustic anisotropy. Alternatively, these measurements can be communicated to a control module or a surface processing facility to be combined there. In either case, the derived acoustic properties are associated with the position of the logging tool 26 to provide a formation property log. A network interface 122 connects the acoustic logging tool 26 to a control/telemetry module via a tool bus, thereby enabling the processor 102 to communicate information to the surface and/or to receive commands from the surface (e.g., activating the tool or changing its operating parameters).

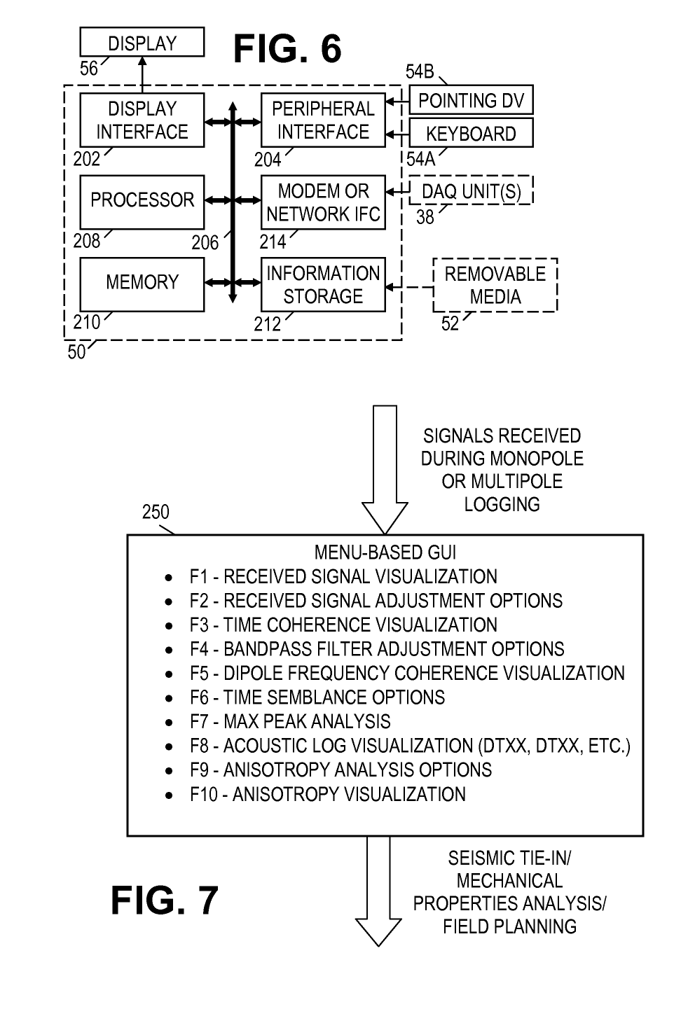

FIG. 6 is a block diagram of an illustrative computer system suitable for providing a menu-based GUI to derive a shear slowness log and/or to perform other operations as described herein. In some embodiments, such computer systems may enable a user to interact with logging tool 26 (e.g., by send commands to BHA 25) to adjust its operation in response to received data. In at least some embodiments, the computer system of FIG. 6 may take the form of a computer that includes a chassis 50, a display 56, and one or more input devices 54A, 54B. Located in the chassis 50 is a display interface 202, a peripheral interface 204, a bus 206, a processor 208, a memory 210, an information storage device 212, and a network interface 214. Bus 206 interconnects the various elements of the computer and transports their communications.

In at least some embodiments, surface telemetry transducers are coupled to the computer system via a data acquisition unit 38 and the network interface 214 to enable the system to communicate with a bottomhole assembly (e.g., BHA 25). In accordance with user input received via peripheral interface 204 and program instructions from memory 210 and/or information storage device 212, the processor processes the received telemetry information received via network interface 214 to construct formation property logs and display them to the user.

The processor 208, and hence the computer system as a whole, generally operates in accordance with one or more programs stored on an information storage medium (e.g., in information storage device 212 or removable information storage media 52). Similarly, a control module for BHA 25 and/or acoustic logging tool controller 102 may operate in accordance with one or more programs stored in an internal memory. One or more of these programs configures the tool controller 102, a control module for BHA 25, and the surface computer system to individually or collectively carry out methods employing a menu-based GUI to derive a shear slowness log as described herein.

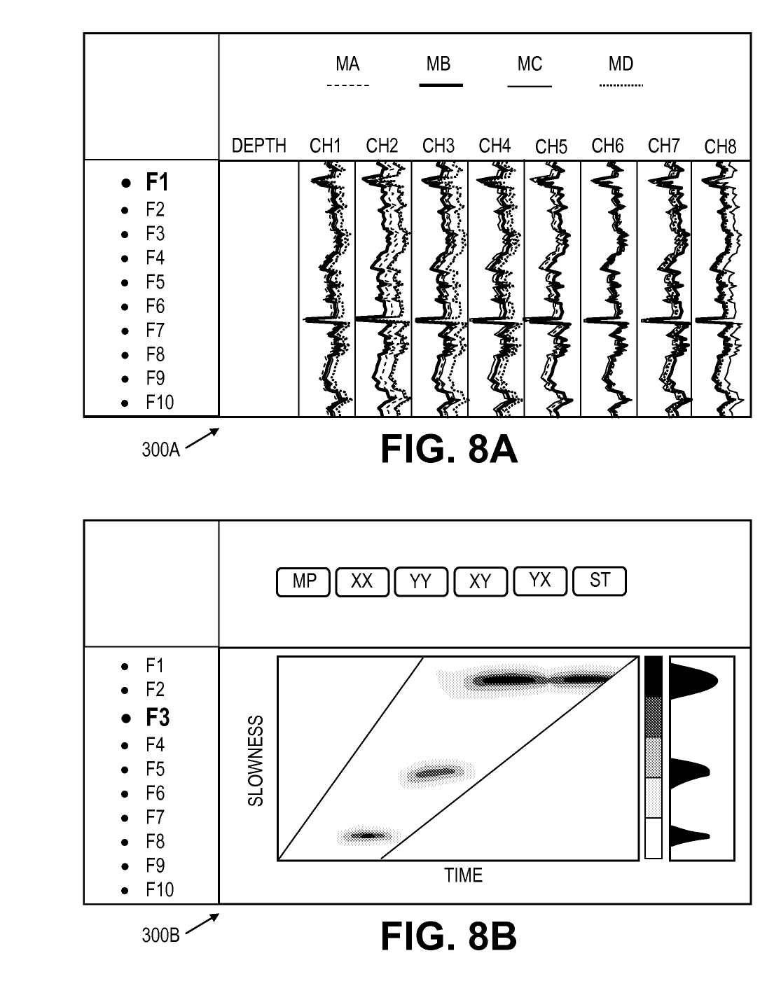

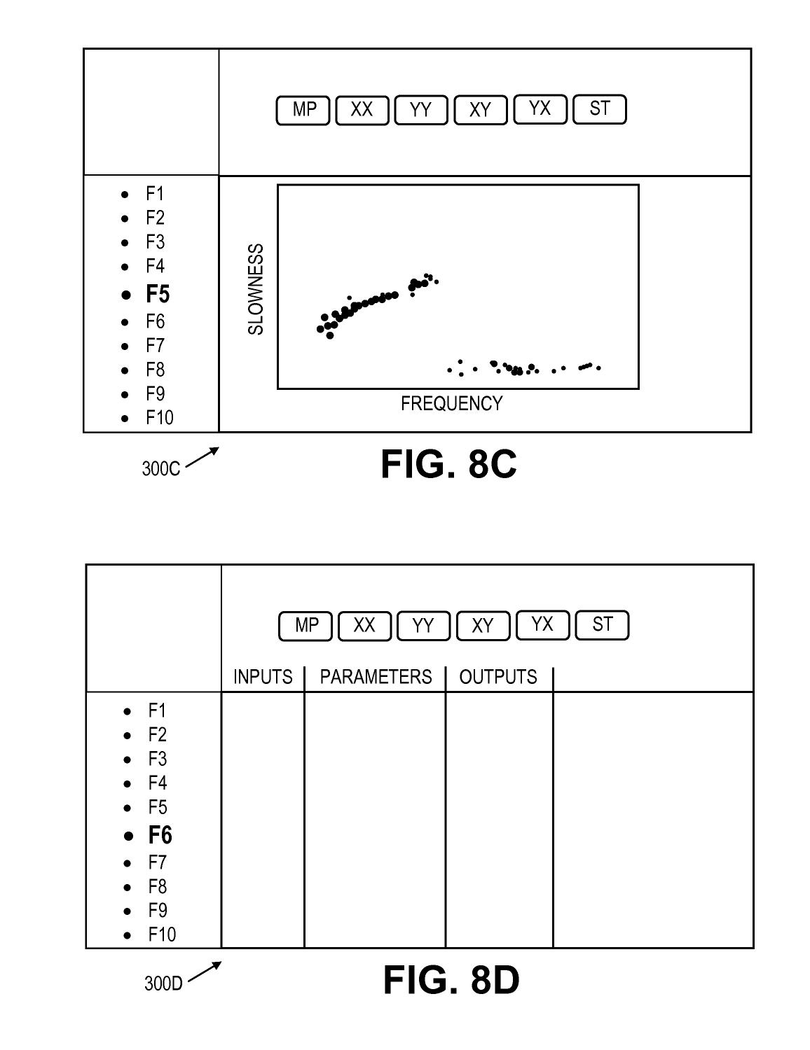

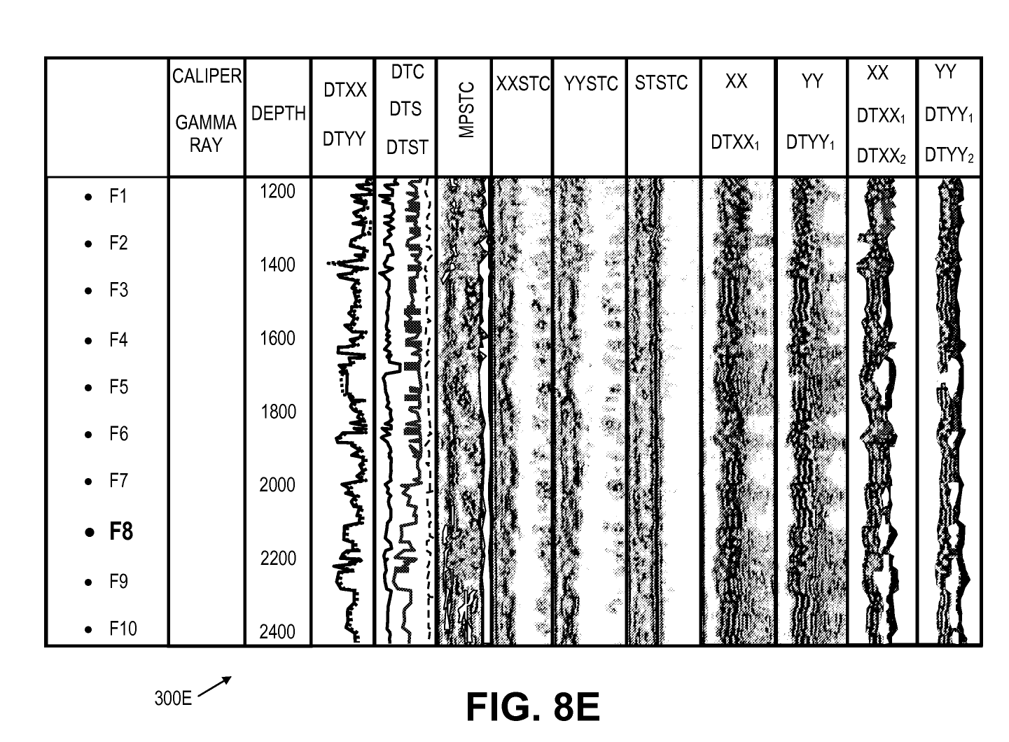

Given the foregoing context, a discussion of menu-based GUIs follows. FIG. 7 shows an example menu-based GUI 250. In FIG. 7, the menu-based GUI 250 supports various functions (labeled F1-F10). F1 is received signal visualization. When F1 selected, a representation of received acoustic signals is displayed. The represented acoustic signals displayed for F1 may be reviewed by a user to assess overall signal quality, signal quality for particular receivers, or comparative signal quality for different receivers. FIG. 8A shows an illustrative screenshot 300A corresponding to F1. In screenshot 300A, different signals (MA, MB, MC, and MD) are plotted as a function of depth for different eight receiver channels. In different embodiments, the number of channels may vary.

F2 is received signal adjustment options. When F2 is selected, a menu or dashboard of received signal adjustment options is displayed. The options for F2 may be selected by a user by entering a value within a range, by selecting options from a list, by adjusting a movable gauge, etc. An example signal adjustment option includes discarding, or otherwise removing from consideration, signals from one or more receivers. Another signal adjustment option includes adjusting a gain applied to a particular signal, to signals of a particular receiver, or to all signals.

F3 is time coherence visualization. When F3 is selected, a representation of time coherence for some or all received acoustic signals is displayed. The represented time coherence displayed for F3 may plot slowness as a function of time for some or all received acoustic signals. The represented time coherence plot displayed for F3 may be reviewed by a user to assess overall signal quality, signal quality for particular receivers, or comparative signal quality for different receivers. FIG. 8B shows an illustrative screenshot 300B corresponding to F3.

F4 is bandpass filter adjustment options. When F4 is selected, a menu or dashboard of bandpass filter adjustment options is displayed. The options for F4 may be selected by a user by entering a value within a range, by selecting options from a list, by adjusting a movable gauge, etc. An example bandpass filter adjustment corresponds to adjusting a frequency band used to remove unwanted artifacts or reduce unwanted attributes from the received acoustic signals.

F5 is dipole frequency coherence visualization. When F5 is selected, a representation of dipole frequency coherence for some or all received acoustic signals is displayed. The represented dipole frequency coherence displayed for F5 may plot slowness as a function of frequency for some or all received acoustic signals. The represented dipole frequency coherence plot displayed for F5 may be reviewed by a user to assess overall signal quality, signal quality for particular receivers, or comparative signal quality for different receivers. FIG. 8C shows an illustrative screenshot 300C corresponding to F5.

F6 is time semblance options. When F6 is selected, a menu or dashboard of time semblance options is displayed. The options for F6 may be selected by a user by entering a value within a range, by selecting options from a list, by adjusting a movable gauge, etc. Example time semblance options include start depth, end depth, slowness time mark options, sampling rate, coherence window, minimum and maximum sonic travel times, number of peaks, etc. FIG. 8D shows an illustrative screenshot 300D corresponding to F6.

F7 is max peaks analysis. When F7 is selected, a representation of maximum peaks resulting from the time semblance options of F6 are displayed. The represented maximum peaks for F7 may be specified in a list or plotted.

F8 is acoustic log visualization. When F8 is selected, a representation of acoustic logs derived from time semblance inversion applied to an initial version or adjusted version of some or all received acoustic signals is displayed. The represented acoustic logs may include, for example, a monopole delta T compressional (DTC) log, a monopole delta T refracted shear (DTRS) log, a monopole semblance (MP STC) log, a dipole delta T shear X direction (DTXX) log, a dispersion corrected dipole delta T shear X direction (DTSXX) log, a dipole semblance X direction (XX STC) log, a dipole delta T shear Y direction (DTYY) log, a dispersion corrected dipole delta T shear Y direction (DTSYY) log, a dipole semblance Y direction (YY STC) log, and/or other logs. Other logs such as a caliper log, a gamma ray log, and a depth may be represented for F8 as well. The represented logs displayed for F8 may be reviewed by a user to assess the quality of inversion for different parameters represented and/or to interpret inversion results. FIG. 8E shows an illustrative screenshot 300E corresponding to F8.

F9 is anisotropy analysis options. When F9 is selected, a menu or dashboard of time anisotropy analysis options is displayed. The options for F9 may be selected by a user by entering a value within a range, by selecting options from a list, by adjusting a movable gauge, etc.

F10 is anisotropy visualization. When F10 is selected, a representation of anisotropy derived using the received acoustic signals, derived acoustic logs, and/or selected anisotropy analysis options is displayed.

It should be appreciated that F1-F10 are examples only and are not intended to limit embodiments to a particular function or set of functions. Further, it should be appreciated that the process of visualizing data (as in F1, F3, F5, F8, and F10) and selecting/adjusting options (as in F2, F4, F6, F7, F9) may be an iterative process, where a user is able to make choices and review the results. As desired, a user can update particular options or undo selected options.

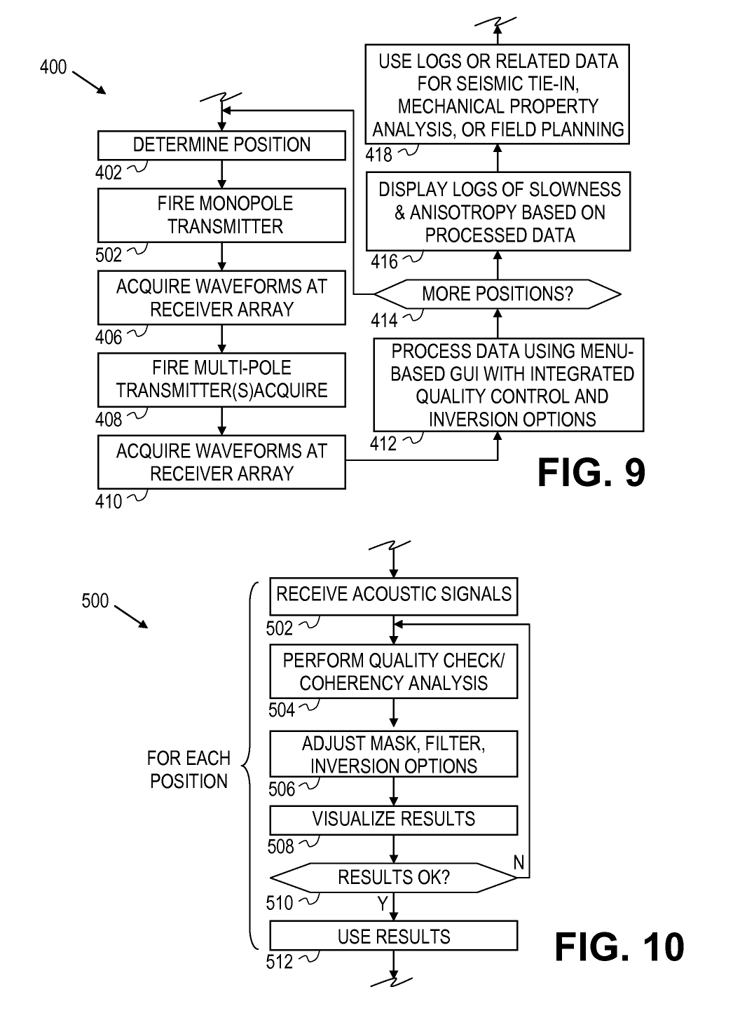

FIG. 9 is a flowchart of an illustrative acoustic logging and data analysis method 400. Beginning in block 402, the position of the logging tool along the borehole is determined. Where the tool provides azimuthal sensitivity, the position determination includes a determination of the tool's rotational orientation. The tool may also measure the acoustical properties of the borehole fluid using a fluid cell. The measured properties would include the acoustic impedance of the borehole fluid, or alternatively the density of the fluid and the propagation velocity of acoustic waves through the fluid. In block 404, the tool fires the monopole transmitter to generate acoustic waves that propagate primarily in the compressional and Stoneley wave modes, and in block 406 the logging tool acquires waveform signals from the receiver array. The signals may be combined to enhance the desired waveform modes before being stored.

In block 408 the tool fires the multi-pole transmitter to generate acoustic waves that propagate in a flexural or higher-order mode. In block 410, the logging tool again acquires waveform signals from the receiver array, this time combining them to enhance the array response to the flexural or higher-order mode. In block 412, data is processed using a menu-based GUI as described herein. In accordance with at least some embodiments, the menu-based GUI integrates quality control and inversion options such that deriving shear slowness logs and/or other logs is facilitated. In block 714, a determination is made regarding whether the logging process should continue, and if so, blocks 702-714 are repeated. In block 716, the shear slowness logs and/or other logs derived at block 712 are displayed. In block 718, the displayed shear slowness logs and/or other logs (or related data) are used for seismic tie-in operations, mechanical properties analysis, and/or field planning.

At least some of the operations described for method 400 may be distributed throughout a logging system or may be concentrated within an internal processor for the logging tool. Thus, for example, position measurements, fluid measurements, and waveform measurements can be collected by separate tools and communicated to a separate processing facility where the menu-based GUI is employed. Moreover, at least some of the operations of method 400 can be carried out in a parallel or asynchronous fashion even though they are described for explanatory purposes as occurring in a sequential order.

FIG. 10 is a flowchart of another illustrative acoustic logging and data analysis method 500 involving a menu-based GUI. At block 502, acoustic signals are received. The acoustic signals may correspond to acoustic signals collected by a logging tool deployed in a downhole environment as described herein. At block 504, a signal quality check and coherence analysis is performed using a menu-based GUI as described herein. For example, the menu-based GUI may display a representation of received acoustic signals, time coherency plots, and dipole frequency coherency plots for some or all of the received acoustic signals. At block 506, the menu-based GUI enables adjustments to masks, filters, and/or inversion options as described herein. At block 508, the results of the adjustments of block 506 are visualized. If the results are determined to be acceptable (determination block 510), the results are stored and may be used for seismic tie-in operations, mechanical properties analysis, field planning, and/or other operations. If the results are determined to be unacceptable (determination block 510), the method 500 returns to block 504. As needed, the method 500 involves iteratively reviewing signal quality and coherency, adjusting mask, filter, and/or inversion options, and visualizing results using a menu-based GUI. The iterative process can be repeated until the results are determined to be acceptable (determination block 510). Alternatively, after a threshold number of iterations, the received acoustic signals may be considered to be unusable. In such case, additional or supplemental acoustic logging operations may be performed using different logging parameters.

Embodiments disclosed herein include:

A: A method that comprises obtaining digitized acoustic signals corresponding to acoustic signals collected by a logging tool deployed in a downhole environment, providing a graphical user interface (GUI) that enables a user to view representations of the digitized acoustic signals and related coherence data, receiving user-input regarding adjustment and inversion options for the digitized acoustic signals via a menu of the GUI, and deriving a shear slowness log for the downhole environment in accordance with the received user-input.

B: A system that comprises a display and at least one processor in communication with the display. The system also comprises a memory in communication with the at least one processor, the at least one memory stores storing digitized acoustic signals collected by a logging tool deployed in a downhole environment and storing instructions. The instructions, when executed, cause the at least one processor to provide a graphical user interface (GUI) on the display, the GUI enabling a user to view representations of the digitized acoustic signals and related coherence data. The instructions, when executed, also cause the at least one processor to receive user-input regarding adjustment and inversion options for the digitized acoustic signals via a menu of the GUI. The instructions, when executed, also cause the at least one processor to derive a shear slowness log for the downhole environment in accordance with the received user-input.

Each of the embodiments, A and B, may have one or more of the following additional elements in any combination. Element 1: further comprising: displaying, by the GUI, a representation of an initial version of digitized acoustic signals received by each of a plurality of acoustic receivers for the logging tool; receiving user-input regarding adjustment options for the initial version of digitized acoustic signals via a menu of the GUI, wherein the adjustment options include a filtering option that filters out all signals for one or more of the acoustic receivers; obtaining a subsequent version of digitized acoustic signals based on the received user-input regarding the filtering option; and deriving the shear slowness log using the subsequent version of digitized acoustic signals. Element 2: further comprising: displaying, by the GUI, a representation of an initial version of digitized acoustic signals received by each of a plurality of acoustic receivers for the logging tool; receiving user-input regarding adjustment options for the initial version of digitized acoustic signals via a menu of the GUI, wherein the adjustment options include a gain option that adjusts a gain for signals corresponding to one or more of the acoustic receivers; obtaining a subsequent version of digitized acoustic signals based on the received user-input regarding the gain option; and deriving the shear slowness log using the subsequent version of digitized acoustic signals. Element 3: further comprising: displaying, by the GUI, a time coherence plot and a frequency coherence plot for an initial version of the digitized acoustic signals; receiving user-input regarding adjustment or inversion options for the initial version of the digitized acoustic signals in response to the displayed time coherence and frequency coherence plots; and deriving the shear slowness log in accordance with the received user-input responsive to the time coherence and frequency coherence plots. Element 4: further comprising: displaying, by the GUI, a time coherence plot and a frequency coherence plot for an adjusted version of the digitized acoustic signals; receiving user-input regarding adjustment or inversion options for the adjusted version of the digitized acoustic signals in response to the displayed time coherence and frequency coherence plots; and deriving the shear slowness log in accordance with the received user-input responsive to the time coherence and frequency coherence plots. Element 5: further comprising: displaying, by the GUI, time semblance options for an initial version of the digitized acoustic signals; receiving user-input regarding the time semblance options; and deriving the shear slowness log in accordance with the received user-input regarding the time semblance options. Element 6: further comprising: displaying, by the GUI, time semblance options for an adjusted version of the digitized acoustic signals; receiving user-input regarding the time semblance options; and deriving the shear slowness log in accordance with the received user-input regarding the time semblance options. Element 7: further comprising: displaying together, by the GUI, the shear slowness log and other logs to enable comparison; receiving user-input regarding adjustment or inversion options for an initial version of the digitized acoustic signals in response to the displayed shear slowness log and other logs; and deriving another shear slowness log in accordance with the received user-input responsive to the displayed shear slowness log and other logs. Element 8: further comprising: displaying together, by the GUI, the shear slowness log and other logs to enable comparison; receiving user-input regarding adjustment or inversion options for an adjusted version of the digitized acoustic signals in response to the displayed shear slowness log and other logs; and deriving another shear slowness log in accordance with the received user-input responsive to the displayed shear slowness log and other logs. Element 9: further comprising performing monopole and multipole acoustic logging operations to collect the acoustic signals. Element 10: further comprising using the shear slowness log for seismic tie-in, mechanical properties analysis, or field planning.

Element 11: wherein the instructions, when executed, further cause the at least one processor to: provide, using the GUI, a representation of an initial version of digitized acoustic signals received by each of a plurality of acoustic receivers for the logging tool; receive, using a menu of the GUI, user-input regarding adjustment options for the initial version of digitized acoustic signals, wherein the adjustment options include a filtering option that filters out all signals for one or more of the acoustic receivers; obtain a subsequent version of digitized acoustic signals based on the received user-input regarding the filtering option; and derive the shear slowness log using the subsequent version of digitized acoustic signals. Element 12: wherein the instructions, when executed, further cause the at least one processor to: provide, using the GUI, a representation of an initial version of digitized acoustic signals received by each of a plurality of acoustic receivers for the logging tool; receive, using a menu of the GUI, user-input regarding adjustment options for the initial version of digitized acoustic signals, wherein the adjustment options include a gain option that adjusts a gain for signals corresponding to one or more of the acoustic receivers; obtain a subsequent version of digitized acoustic signals based on the received user-input regarding the gain option; and derive the shear slowness log using the subsequent version of digitized acoustic signals. Element 13: wherein the instructions, when executed, further cause the at least one processor to: provide, using the GUI, a time coherence plot and a frequency coherence plot for an initial version of the digitized acoustic signals; receive, using a menu of the GUI, user-input regarding adjustment or inversion options for the initial version of the digitized acoustic signals in response to the time coherence and frequency coherence plots; and derive the shear slowness log in accordance with the received user-input responsive to the time coherence and frequency coherence plots. Element 14: wherein the instructions, when executed, further cause the at least one processor to: provide, using the GUI, a time coherence plot and a frequency coherence plot for an adjusted version of the digitized acoustic signals; receive, using a menu of the GUI, user-input regarding adjustment or inversion options for the adjusted version of the digitized acoustic signals in response to the displayed time coherence and frequency coherence plots; and derive the shear slowness log in accordance with the received user-input responsive to the time coherence and frequency coherence plots. Element 15: wherein the instructions, when executed, further cause the at least one processor to: provide, using the GUI, time semblance options for an initial or adjusted version of the digitized acoustic signals; receive, using a menu of the GUI, user-input regarding the time semblance options; and derive the shear slowness log in accordance with the received user-input regarding the time semblance options. Element 16: wherein the instructions, when executed, further cause the at least one processor to: provide together, using the GUI, the shear slowness log and other logs; receive, using a menu of the GUI, user-input regarding adjustment or inversion options for an initial or adjusted version of the digitized acoustic signals in response to the provided shear slowness log and other logs; and derive another shear slowness log in accordance with the received user-input responsive to the provided shear slowness log and other logs. Element 17: further comprising a controller for directing monopole and multipole acoustic logging operations of the logging tool to collect the acoustic signals. Element 18: further comprising further comprising a controller for directing subsequent logging operations of the logging tool based on the shear slowness log.

Numerous variations and modifications will become apparent to those skilled in the art once the above disclosure is fully appreciated. For example, the logging tools described herein can be implemented as logging while drilling tools and as wireline logging tools. It is intended that the following claims be interpreted to embrace all such variations and modifications where applicable.

1. A method that comprises:
obtaining digitized acoustic signals corresponding to acoustic signals collected by a logging tool deployed in a downhole environment;
providing a graphical user interface (GUI) that enables a user to view representations of the digitized acoustic signals and related coherence data;
receiving user-input regarding adjustment and inversion options for the digitized acoustic signals via a menu of the GUI; and
deriving a shear slowness log for the downhole environment in accordance with the received user-input.

2. The method of claim 1, further comprising:
displaying, by the GUI, a representation of an initial version of digitized acoustic signals received by each of a plurality of acoustic receivers for the logging tool;
receiving user-input regarding adjustment options for the initial version of digitized acoustic signals via a menu of the GUI, wherein the adjustment options include a filtering option that filters out all signals for one or more of the acoustic receivers;
obtaining a subsequent version of digitized acoustic signals based on the received user-input regarding the filtering option; and
deriving the shear slowness log using the subsequent version of digitized acoustic signals.

3. The method of claim 1, further comprising:
displaying, by the GUI, a representation of an initial version of digitized acoustic signals received by each of a plurality of acoustic receivers for the logging tool;
receiving user-input regarding adjustment options for the initial version of digitized acoustic signals via a menu of the GUI, wherein the adjustment options include a gain option that adjusts a gain for signals corresponding to one or more of the acoustic receivers;
obtaining a subsequent version of digitized acoustic signals based on the received user-input regarding the gain option; and
deriving the shear slowness log using the subsequent version of digitized acoustic signals.

4. The method of claim 1, further comprising:
displaying, by the GUI, a time coherence plot and a frequency coherence plot for an initial version of the digitized acoustic signals;
receiving user-input regarding adjustment or inversion options for the initial version of the digitized acoustic signals in response to the displayed time coherence and frequency coherence plots; and
deriving the shear slowness log in accordance with the received user-input responsive to the time coherence and frequency coherence plots.

5. The method of claim 1, further comprising:
displaying, by the GUI, a time coherence plot and a frequency coherence plot for an adjusted version of the digitized acoustic signals;
receiving user-input regarding adjustment or inversion options for the adjusted version of the digitized acoustic signals in response to the displayed time coherence and frequency coherence plots; and
deriving the shear slowness log in accordance with the received user-input responsive to the time coherence and frequency coherence plots.

6. The method of claim 1, further comprising:
displaying, by the GUI, time semblance options for an initial version of the digitized acoustic signals;
receiving user-input regarding the time semblance options; and
deriving the shear slowness log in accordance with the received user-input regarding the time semblance options.

7. The method of claim 1, further comprising:
displaying, by the GUI, time semblance options for an adjusted version of the digitized acoustic signals;
receiving user-input regarding the time semblance options; and
deriving the shear slowness log in accordance with the received user-input regarding the time semblance options.

8. The method of claim 1, further comprising:
displaying together, by the GUI, the shear slowness log and other logs to enable comparison;
receiving user-input regarding adjustment or inversion options for an initial version of the digitized acoustic signals in response to the displayed shear slowness log and other logs; and
deriving another shear slowness log in accordance with the received user-input responsive to the displayed shear slowness log and other logs.

9. The method of claim 1, further comprising:
displaying together, by the GUI, the shear slowness log and other logs to enable comparison;
receiving user-input regarding adjustment or inversion options for an adjusted version of the digitized acoustic signals in response to the displayed shear slowness log and other logs; and
deriving another shear slowness log in accordance with the received user-input responsive to the displayed shear slowness log and other logs.

10. The method of claim 1, further comprising performing monopole and multipole acoustic logging operations to collect the acoustic signals.

11. The method of claim 1, further comprising using the shear slowness log for seismic tie-in, mechanical properties analysis, or field planning.

12. A system that comprises:
a display;
at least one processor in communication with the display;
at least one memory in communication with the at least one processor, the at least one memory storing digitized acoustic signals corresponding to acoustic signals collected by a logging tool deployed in a downhole environment and storing instructions that, when executed, cause the at least one processor to:
provide a graphical user interface (GUI) on the display, the GUI enabling a user to view representations of the digitized acoustic signals and related coherence data;
receive user-input regarding adjustment and inversion options for the digitized acoustic signals via a menu of the GUI; and
derive a shear slowness log for the downhole environment in accordance with the received user-input.

13. The system of claim 12, wherein the instructions, when executed, further cause the at least one processor to:
provide, using the GUI, a representation of an initial version of digitized acoustic signals received by each of a plurality of acoustic receivers for the logging tool;
receive, using a menu of the GUI, user-input regarding adjustment options for the initial version of digitized acoustic signals, wherein the adjustment options include a filtering option that filters out all signals for one or more of the acoustic receivers;
obtain a subsequent version of digitized acoustic signals based on the received user-input regarding the filtering option; and
derive the shear slowness log using the subsequent version of digitized acoustic signals.

14. The system of claim 12, wherein the instructions, when executed, further cause the at least one processor to:
provide, using the GUI, a representation of an initial version of digitized acoustic signals received by each of a plurality of acoustic receivers for the logging tool;
receive, using a menu of the GUI, user-input regarding adjustment options for the initial version of digitized acoustic signals, wherein the adjustment options include a gain option that adjusts a gain for signals corresponding to one or more of the acoustic receivers;
obtain a subsequent version of digitized acoustic signals based on the received user-input regarding the gain option; and
derive the shear slowness log using the subsequent version of digitized acoustic signals.

15. The system of claim 12, wherein the instructions, when executed, further cause the at least one processor to:
provide, using the GUI, a time coherence plot and a frequency coherence plot for an initial version of the digitized acoustic signals;
receive, using a menu of the GUI, user-input regarding adjustment or inversion options for the initial version of the digitized acoustic signals in response to the time coherence and frequency coherence plots; and
derive the shear slowness log in accordance with the received user-input responsive to the time coherence and frequency coherence plots.

16. The system of claim 12, wherein the instructions, when executed, further cause the at least one processor to:
provide, using the GUI, a time coherence plot and a frequency coherence plot for an adjusted version of the digitized acoustic signals;
receive, using a menu of the GUI, user-input regarding adjustment or inversion options for the adjusted version of the digitized acoustic signals in response to the displayed time coherence and frequency coherence plots; and
derive the shear slowness log in accordance with the received user-input responsive to the time coherence and frequency coherence plots.

17. The system of claim 12, wherein the instructions, when executed, further cause the at least one processor to:
provide, using the GUI, time semblance options for an initial or adjusted version of the digitized acoustic signals;
receive, using a menu of the GUI, user-input regarding the time semblance options; and
derive the shear slowness log in accordance with the received user-input regarding the time semblance options.

18. The system of claim 12, wherein the instructions, when executed, further cause the at least one processor to:
provide together, using the GUI, the shear slowness log and other logs;
receive, using a menu of the GUI, user-input regarding adjustment or inversion options for an initial or adjusted version of the digitized acoustic signals in response to the provided shear slowness log and other logs; and
derive another shear slowness log in accordance with the received user-input responsive to the provided shear slowness log and other logs.

19. The system of claim 12, further comprising a controller for directing monopole and multipole acoustic logging operations of the logging tool to collect the acoustic signals.

20. The system of claim 12, further comprising a controller for directing subsequent logging operations of the logging tool based on the shear slowness log.
